(19) United States
(12) Patent Application Publication
(10) Pub. No.: US 2012/0256748 A1
(43) Pub. Date: Oct. 11, 2012

(54) Disc media securement

(76) Inventor: Tami (Tammy) A. Russell, Rock Island, IL (US)

(21) Appl. No.: 12/926,503

(22) Filed: Nov. 22, 2010

Related U.S. Application Data
(60) Provisional application No. 61/265,714, filed on Dec. 1, 2009.

(51) Int. Cl. G08B 13/14; G11B 23/03

(52) U.S. Cl. 340/572.1; 720/734; 720/728; G9B/23.02

(57) ABSTRACT

An optical media case having a top portion with an aperture and a bottom portion also having a aperture positioned therein. A hinged portion, said hinged portion connected between said top portion and said bottom portion to form an enclosure. An EAS device comprising a first portion, a second portion and a connector, wherein the first portion and second portion are attached to each other via the connector. An optical media having a central opening placed between the first portion and the second portion to fully enclose the optical media so that the first aperture, second aperture and central opening are aligned and wherein the EAS device first portion is located external and adjacent the top portion, and the EAS device second portion is located external and adjacent the bottom portion and the connector is positioned within the central opening of the optical media.

### CROSS-REFERENCE TO RELATED APPLICATIONS

Not Applicable

### FIELD OF THE INVENTION

The present invention relates to disc media securement, and more particularly to protecting items such as CD-roms or DVDs from theft.

### STATEMENT REGARDING FEDERALLY SPONSORED RESEARCH OR DEVELOPMENT

No federal funds were used to develop or create the invention disclosed and described in the patent application.

### REFERENCE TO SEQUENCE LISTING, A TABLE, OR A COMPUTER PROGRAM LISTING COMPACT DISK APPENDIX

Not Applicable

### AUTHORIZATION PURSUANT TO 37 C.F.R. §1.171 (d)

A portion of the disclosure of this patent document may contain material that is subject to copyright and trademark protection. The copyright owner has no objection to the facsimile reproduction by anyone of the patent document or the patent disclosure, as it appears in the Patent and Trademark Office patent file or records, but otherwise reserves all copyrights whatsoever.

### BACKGROUND

Optical data storage media such as CD's (Compact Discs), DVD's (Digital Video Discs or Digital Variety Discs), DVD-ROM, and CDROM's are used to distribute software, games, movies, and the like. Various electronic and mechanical devices have been provided for tracking and monitoring of goods and containers. These devices include acoustic magnetic security strips and radio frequency security tags. These devices often are embodied in tags, pods, labels, or patches, having adhesive surfaces for attaching the device to the goods or their containers. These devices facilitate tracking and monitoring of goods and containers. The security devices are typically attached to the articles particularly susceptible to pilferage and improper removal from a warehouse or retail store. The security devices include a detectable sensor. One known type of security tag has a circuit that resonates at a predetermined detection frequency range. A transmitter provides electromagnetic energy that excites the circuit. A receiver detects the output signal from the resonating circuit. The transmitter and the receiver are located at detection points, often exits from retail facilities. As the article is carried through the detection point, the receiver signals an alert when an activated sensor device is detected. For articles that are permitted to pass (such as purchased DVDs), a separate device is used to deactivate the detectable sensor prior to passage. Other devices include RFID devices that communicate digital signals. In some known RFID devices, the signal is indicative of unique identifiers for tracking particular containers.

Often large retailers require manufacturers of articles to include tracking and monitoring devices within the containers for the articles. For smaller retailers and smaller inventories of articles, the tracking and monitoring devices may not be included with or attached to containers. In such circumstances, the articles may be provided with after-market tracking and monitoring devices. For example, electronic article surveillance tags are available with adhesive backing to secure the tags to the containers. While the containers are thereby subject to electronic article surveillance, the adhesively attached tags experience problems during use. One significant problem is that the tags, being on the exterior of the container, are susceptible to removal. Removing the security tag facilitates unauthorized removal of the article from the secured area. However, removal by a purchaser also causes problems. The covering to which the security tag attaches may become torn or ripped. The package with the security tag, or without such by removal is unattractive. The security tag may also overlie or cover over ornamental graphics or text on the packaging.

FIG. 1 and FIG. 2 represent examples of the prior art as found in U.S. Pat. No. 7,602,300, which is incorporated by reference herein. FIG. 1 illustrates an alternate embodiment of a hard cover product 50 according to the prior art. In this embodiment, a substantially planner radio frequency tag 52 attaches to the surface of the sheet 14a. The inner liner 18 attaches in overlaying relation to the sheets 14, 16. In the illustrated embodiment, which does not include the recess 32, the inner liner 18 extends over the area of the spine. The inner liner 18 thereby overlies and concealing encloses the sheet-like security tag 52. The security tag 52 is perceptible as a slight bulge, but generally does not detract from the graphics or text on the inner liner.

In the illustrated embodiment, the hard cover product 50 attaches to an interior body, such as plastic matingly engagable plastic diskholders, configured for receiving compact discs or DVD discs. However, the interior body may be a bound assembly of papers for a book. Other shell devices that define an interior body for the hard cover product may be gainfully attached to the interior front and back covers, such as for packaging small articles, video tapes, books, ring binders, or other articles. FIG. 2 illustrates the hard cover product 50 in which the outer liner 12 includes an indicia 62 such as a bar code or other product inventory number. In this embodiment, the recess 32 for the security tag 24 (or security tag 52 attached to the sheet 14) is disposed substantially in alignment with the indicia 62. In this way, a security tag detector deactivates the security tag when the hard cover product 30 is scanned for pricing, so that the product can be taken from a store without triggering alarms.

Other Prior art which may be of interest to the present invention and which is incorporated by reference is:

U.S. Patent Documents

| | | |
|---|---|---|
| 3,938,831 | February 1976 | Herman |
| 4,709,813 | December 1987 | Wildt |
| 4,784,264 | November 1988 | Sykes |
| 4,881,061 | November 1989 | Chambers |
| 4,966,020 | October 1990 | Fotheringham et al. |
| 5,031,756 | July 1991 | Buzzard et al. |
| 5,209,086 | May 1993 | Bruhwiler |
| 5,236,081 | August 1993 | Fitzsimmons et al. |
| 5,260,690 | November 1993 | Mann et al. |
| 5,276,435 | January 1994 | Rossides |
| 5,297,672 | March 1994 | MacTavish |
| 5,331,313 | July 1994 | Koning |
| 5,440,296 | August 1995 | Nelson |
| 5,477,219 | December 1995 | Zarembo et al. |
| 5,500,640 | March 1996 | Zhou et al. |
| 5,598,728 | February 1997 | Lax |
| 5,620,271 | April 1997 | Bergh et al. |
| 5,656,998 | August 1997 | Fujiuchi et al. |
| 5,680,782 | October 1997 | Komatsu et al. |
| 5,718,332 | February 1998 | Tachibana |
| 5,745,036 | April 1998 | Clare |
| 5,749,735 | May 1998 | Redford et al. |
| 5,762,377 | June 1998 | Chamberlain |
| 5,782,350 | July 1998 | Weisburn et al. |
| 5,802,890 | September 1998 | Espada-Velasco |
| 5,812,065 | September 1998 | Schrott et al. |
| 5,823,341 | October 1998 | Nakasuji |
| 5,847,649 | December 1998 | Collins et al. |
| 5,850,752 | December 1998 | Lax |
| 5,882,052 | March 1999 | Whitehead |
| 5,910,770 | June 1999 | Ohara |
| 5,984,388 | November 1999 | Bacon |
| 5,988,376 | November 1999 | Lax |
| 6,082,156 | July 2000 | Bin |
| 6,094,137 | July 2000 | Rasch et al. |
| 6,100,804 | August 2000 | Brady et al. |
| 6,142,697 | November 2000 | Williams |
| 6,155,087 | December 2000 | Necchi |
| 6,222,453 | April 2001 | Joyce |
| 6,244,462 | June 2001 | Ehrensvard et al. |
| 6,276,523 | August 2001 | Sanders |
| 6,374,648 | April 2002 | Mitsuyama |
| 6,497,125 | December 2002 | Necchi |
| 6,601,415 | August 2003 | Takinami |
| 6,614,750 | September 2003 | Weber et al. |
| 6,616,035 | September 2003 | Ehrensvard et al. |
| 6,619,079 | September 2003 | Cheung |
| 6,628,199 | September 2003 | Ehrensvard et al. |
| 6,888,509 | May 2005 | Atherton |
| 6,894,616 | May 2005 | Forster |
| 6,937,153 | August 2005 | Redlin |
| 6,947,371 | September 2005 | Bigley |
| 7,008,134 | March 2006 | Lane |
| 2002/0134119 | September 2002 | Derman |
| 2002/0149479 | October 2002 | Duschek et al. |
| 2002/0196126 | December 2002 | Eisenberg et al. |
| 2003/0019770 | January 2003 | Hodes |
| 2003/0094021 | May 2003 | Takinami |
| 2003/0131638 | July 2003 | Chang |
| 2003/0145635 | August 2003 | Sheslow |
| 2003/0168514 | September 2003 | Rancien et al. |
| 2003/0234190 | December 2003 | Kuo |
| 2004/0008613 | January 2004 | Beckwith et al. |
| 2004/0066029 | April 2004 | Parker |
| 2006/0116899 | June 2006 | R. Lax et al. |

Foreign Patent Documents

| | | |
|---|---|---|
| 2559492 | July, 2003 | CN |
| 3212039 | October, 1983 | DE |
| 4226237 | February, 1994 | DE |
| 2746191 | September, 1997 | FR |
| WO 9315294 | August, 1993 | WO |
| 9524703 | September, 1995 | WO |

### OTHER REFERENCES

“The Henderson Network”; web page article from http://www.cypak.com/index.php?a=pressroom&b=newscomdex021121; Aug. 18, 2004; www.cypak.com, Cypak AB, Funckens Grand 1, Box 2332, 103 18 Stockholm, Sweden. cited by other
“Roland Piquepaille's Technology Trends”; “Cypak Mounts CPUs On Paper. Can Disposable PC's be far off?”; web page article from http://radio.weblogs.com/0105910/2003/02/03.html; Jan. 3, 2004. cited by other.
RFID Journal “The Package Is the Computer”; web page article from http://www.rfidjournal.com/article/view/301; Feb. 11, 2003. cited by other.
“04 01 13 Cypak signs agreement to license proprietary intelligent pharmaceutical packaging technology to MeadWestvaco Healthcare Packaging; web page article from http://.cypak.com?test.sub.--site/index.php?a=pressromm&b=news&page=news.- sub.--meadwestvaco04 . . . ”; Jan. 13, 2004; www.cypak.com, Cypak, AB, Funkens Grand 1, Box 2332, 103 18 Stockholm, Sweden. cited by other.
MeadWestvaco, Healthcare Packaging, announcement, New York, N.Y. Apr. 2, 2004, “MeadWestvaco Healthcare Packaging enhance electronic compliance packaging offering using Cypak AB Products”. cited by other.
Smart Healthcare USA 2004, “RFID and Smart Packaging in healthcare”; web page article from http://www.idtechex.com/smarthealthcareusa/4.asp; Jun. 10-11, 2004. cited by other.
“The Swedish Industrial Development Fund and IT Provider invest in Cypak”; web page article from http://64.233.179.104/search?q=cache:rKf2CZYzvIoJ:cypak.vnewscenter.com/p-ress.jsp%3Fid%3 . . . ; Aug. 18, 2004, www.cypak.com, Cypak AB, Funckens Grand 1, Box 2332, 103 18 Stockholm, Sweden. cited by other.
Conference Report: “Smarter Packaging”, Packworld.com Packaging World Magazine; web page article from http://www.packworld.com/articles/Features/18411html, November 2004. cited by other. The Endpaper, “RFID Tags and the ALA”, p. 9, Library Binding Institute, 14 Bay Tree Lane, Tequesta, Fla. 33469 (May 2005). cited by other.
MSN Search “acousticmagnetic” listing Sentech Acousto-Magnetic (AM) Tags, www.sentecheas.com (search conducted Aug. 12, 2004). cited by other.
Sentech EAS Corporation, www.sentecheas.com, Product Listing (2 p), RF Technology (1 p), and About Sentech (1 p), (prior to Apr. 14, 2004). cited by other.
International Search Report, PCT/US05/13105 (Jan. 31, 2007). cited by other.
“About SenTech”; web page article from http://www.sentecheas.com/about.htm; www.cypak.com, Sen Tech EAS Corporation, 2843 Centerport Circle, Pompano Beach, Fla. 33064; at least as early as April 2004. cited by other.
“Intelligent Pharmaceutical Packaging”; “Summary” and IPP PowerPoint™ presentation from http://www.cypak.com/index.php?a=products&b=ipp&c=summary&page=products.s- ub.--ipp; www.cypak.com, Cypak AB, Funckens Grand 1, Box 2332, 1103 18 Stockholm, Sweden; at least as early as April 2004. cited by other.
“Intelligent Pharmaceutical Packaging”; “Articles”; web page article from http://www.cypak.com/index.php?a=pressroom&b=articles&page=pressroom.sub.- --articles; www.cypak.com, Cypak AB, Funckens Grand 1, Box 2332, 103 18 Stockholm, Sweden; at least as early as April 2004. cited by other.
“The Connected Drug Box”; web page article from http: . . . web.archive.org/web/20021209044120/cypak.com/index.php?a=pressroom-&b=news&page . . . ; www.cypak.com, Cypak AB, Funckens Grand 1, Box 2332, 103 18 Stockholm, Sweden; at least as early as April 2004. cited by other.
“Electronic Compliance Packaging”; web page article from http://web.archive.org'web/20030409195629/www.cypak.com/index.php?a=products&b=packaging& page=products.sub.--packaging; www.cypak.com, Cypak AB, Funckens Grand 1, Box 2332, 103 18 Stockholm, Sweden; at least as early as April 2004. cited by other. “We are innovators . . . ”; web page article from
http://web.archive.org/web/20031206192144/http://cypak.com; www.cypak.com, Cypak AB, Funckens Grand 1, Box 2332, 103 18 Stockholm, Sweden; at least as early as April 2004. cited by other
KR 535 Tabmaster Product Flyer, “The KR 535 makes tabbing of paper products faster and easier than ever. Here's why . . . ”, Kirk Rudy, Inc., 2700 Kennesaw Due West Road, Kennesaw, Ga., USA 30144; at least as early as April 2004. cited by other.
KR 203P Attaching System Product Flyer, “The KR 203P attaches a wide variety of cards and pre-packaged samples onto various mailers and inserts”, Kirk Rudy, Inc., 2700 Kennesaw Due West Road, Kennesaw, Ga., USA 30144; at least as early as April 2004. cited by other.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limited of its scope, the invention will be described and explained with additional specificity and detail through the use of the accompanying drawings.

FIG. 1 illustrates an embodiment of a prior art disk securement device as found in the prior art, which is FIG. 5 in U.S. Pat. No. 7,602,300.

FIG. 2 illustrates another embodiment of a prior art disk securement device as found in the prior art, which is FIG. 6 in U.S. Pat. No. 7,602,300.

FIG. 3 illustrates a modification of the prior art disk securement device as found in the prior art at FIG. 5 of U.S. Pat. No. 7,602,300, to implement the present art.

FIG. 4 illustrates another view of FIG. 11 which embodies the present art adapted to the prior art disk securement device at FIG. 6 of U.S. Pat. No. 7,602,300, to implement the present art.

FIG. 5 illustrates a top view of the optical media container of the present art and an EAS device configured to work with the optical media container.

FIG. 6 illustrates a side view of the optical media container of the present art.

FIGS. 6A and 6B provide exploded views of the EAS device illustrated in FIG. 4.

FIG. 7A is a top view of a prototype container of the present art for a CD or DVD.

FIG. 7B is a view of a prototype case open with a disk resting on the interior of the bottom portion of the case.

FIG. 8 is a top view of the top portion of the prototype container illustrated in FIG. 5.

FIG. 9 illustrates a bottom view of the bottom portion of the prototype container of the present art for a CD or DVD or other disk media.

FIG. 10 illustrates how an EAS device could be used along with the bottom portion of the prototype present art container for a CD or DVD, as illustrated in FIGS. 6-8. FIG. 8 is lower side of the bottom portion and an existing EAS device which could be modified and placed in the modified portion of bottom portion.

FIG. 11 illustrates another embodiment of the present art disc securement method disclosed herein mounted upon a base portion.

FIG. 12 illustrates a top view of the optical media container of the present art.

DETAILED DESCRIPTION - ELEMENT LISTING

| Description | Element No. |
|---|---|
| Disk Case - prior art | 10 |
| Aperture | 11 |
| Disk Case - wall | 12 |
| Disk Pedestal - outer rim | 13 |
| Disk Pedestal - inner hub | 14 |
| Disk Center | 15 |
| Disk Case - top portion | 16 |
| Disk Case - bottom portion | 17 |
| Disk Case - interior portion | 58 |
| Disk Case - aperture wall | 19 |
| Disk Case - present art | 20 |
| EAS Bottom Portion | 21 |
| EAS Pin | 22 |
| EAS Top Portion | 23 |
| EAS Device | 24 |
| Recessed Portion | 25 |
| Disk | 26 |
| Hinged portion | 27 |
| Shield | 28 |
| Pin hole | 29 |
| Locking Pin | 30 |
| Centering cylinder | 31 |
| Mounting base | 32 |
| Enlarged portion | 33 |
| Disk Case - Positioning Scallop | 60 |

### DETAILED DESCRIPTION

Before the various embodiments of the present invention are explained in detail, it is to be understood that the invention is not limited in its application to the details of construction and the arrangements of components set forth in the following description or illustrated in the drawings. The invention is capable of other embodiments and of being practiced or of being carried out in various ways. Also, it is to be understood that phraseology and terminology used herein with reference to device or element orientation (such as, for example, terms like “front”, “back”, “up”, “down”, “top”, “bottom”, and the like) are only used to simplify description of the present invention, and do not alone indicate or imply that the device or element referred to must have a particular orientation. In addition, terms such as “first”, “second”, and “third” are used herein and in the appended claims for purposes of description and are not intended to indicate or imply relative importance or significance.

### DEFINITIONS

Although the present invention and its associated methodology may be described with respect to a single type of optical storage media, the ordinarily skilled artisan will readily appreciate that these teachings may also be applied to other types of optical storage media.

“Electronic article surveillance” and “EAS” herein refers to commercially available systems for inhibiting the theft of goods from retail stores using an active tag associated with each article, which triggers an alarm when entering an interrogation zone at the store exit. The EAS tag reacts to signals transmitted by EAS security devices positioned at the exits of the store. Upon being interrogated by a specific signal, the EAS tag is adapted to emit a signal that is detectable by an EAS receiver, which can then activate an alarm. The preferred anti-theft device is integral to the primary package, increasing the security of the overall package. There are several types of EAS systems presently in use including RF, microwave, harmonic, and acoustomagnetic or magnetomechanical techniques for spatial magnetic interrogation and novel tags. EAS technology is disclosed e.g. in U.S. Pat. No. 5,744,791 (Isaac et al.), U.S. Pat. No. 5,859,587 (Alicot et al.), U.S. Pat. No. 5,884,425 (Baldwin), all incorporated by reference herein in their entirety. The technology described in WO 96/31790, sometimes referred to as “Flying Null” technology, is based on exploiting the behavior of magnetic materials as they pass through a region of space containing a magnetic null. Passive tags containing one or more magnetic elements can perform as remotely-readable data carriers, the number and spatial arrangement of the elements representing information such as a unique package identifier.

The present invention relates to a theft proof fastening for a DVD, or other optical media container, and more particularly to a theft proof fastening which incorporates EAS for a DVD container that prevents the compact disk from being stolen away from the outer DVD container.

### DESCRIPTION OF THE PROBLEM

Since the application of compact disks is popular, many products make use of compact disks such as DVD as data storage media and the products are sold with the advantages of the compact disk. However, compact disk providers may have their compact disk stolen without even knowing it and at great economic cost. Although magnetic sensors can be installed in the DVD container and a retailer may notice such once the sensor at the door initiates the alarm, the potential thief is only interested in the compact disk itself, and the thief may steal the compact disk by one of the following ways:

1. Firstly, press the positioning structure at the central hole of the compact disk to detach the compact disk from the positioning structure.
2. Cut a slit along the notch of the DVD container which is packaged by a transparent plastic membrane outside the DVD container.
3. Shake the DVD container until the compact disk inside the DVD container falls out from the notch of the DVD container and the slit of the transparent plastic membrane.
4. Put the DVD container back into the original position and take away the compact disk. Since the compact disk has no magnetic sensing material on it, a potential thief can successfully take away the compact disk. The problem at this time is more serious than the theft itself because the DVD container has no DVD disk in it, and the people of the shop do not realize their has been a theft. When a customer buys such a compact disk, the customer generally will not notice the small slit on the transparent plastic membrane when making payment at the cashier, but as soon as the customer opens the package and discovers the compact disk is missing, the customer will definitely ask for compensation from the shop. It does not only cost damages to the business itself, but also to the reputation of the company.

It is clear then that the present art is intended to alleviate this problem by incorporating EAS technology into the packaging of the DVD itself while burglar or theft proofing the packaging for the DVD by not allowing the removal of the DVD from the package without triggering the EAS alarm system.

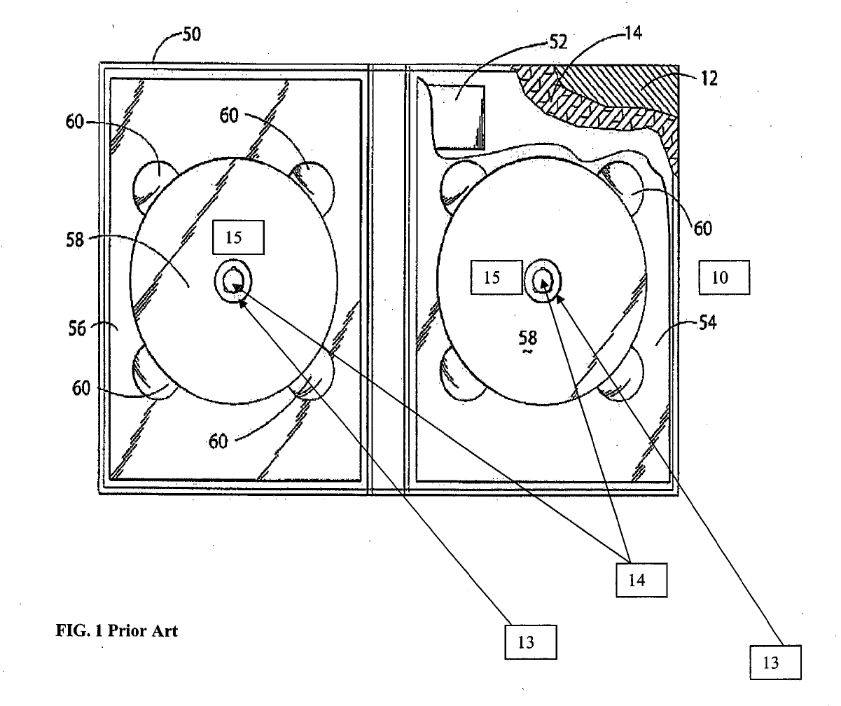

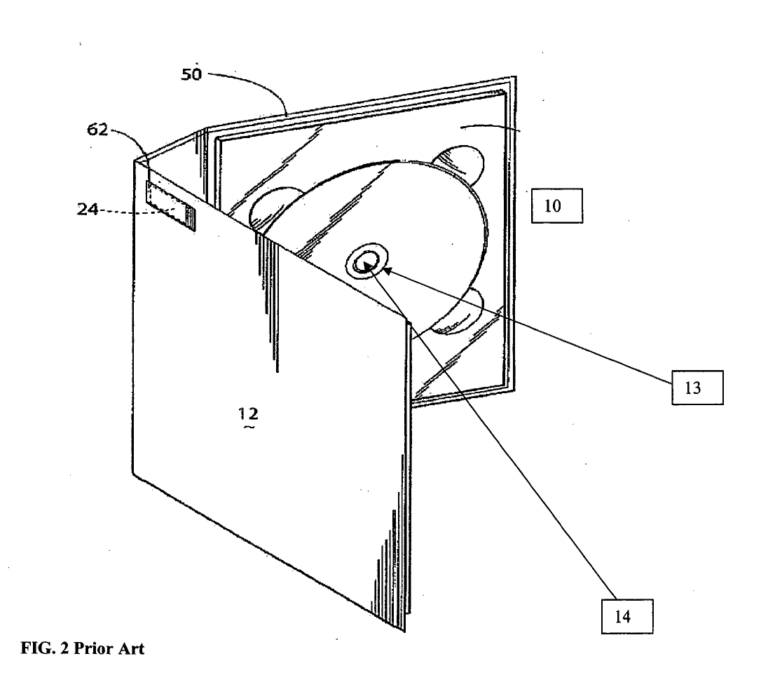

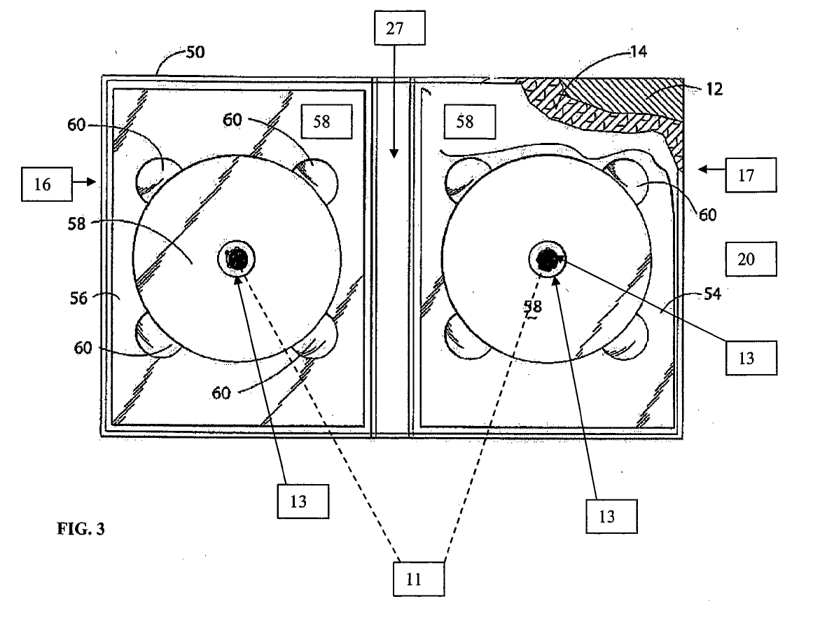

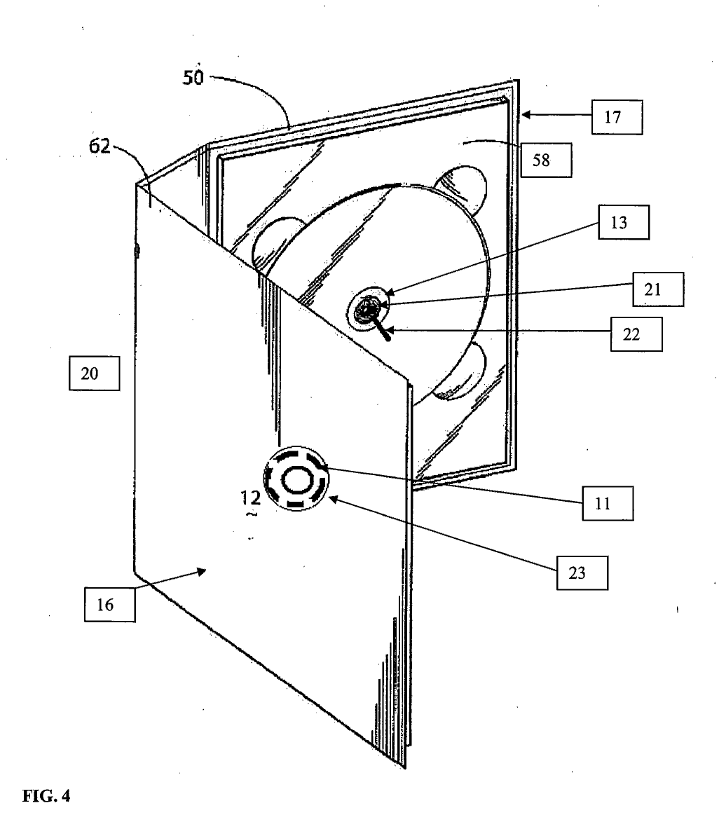

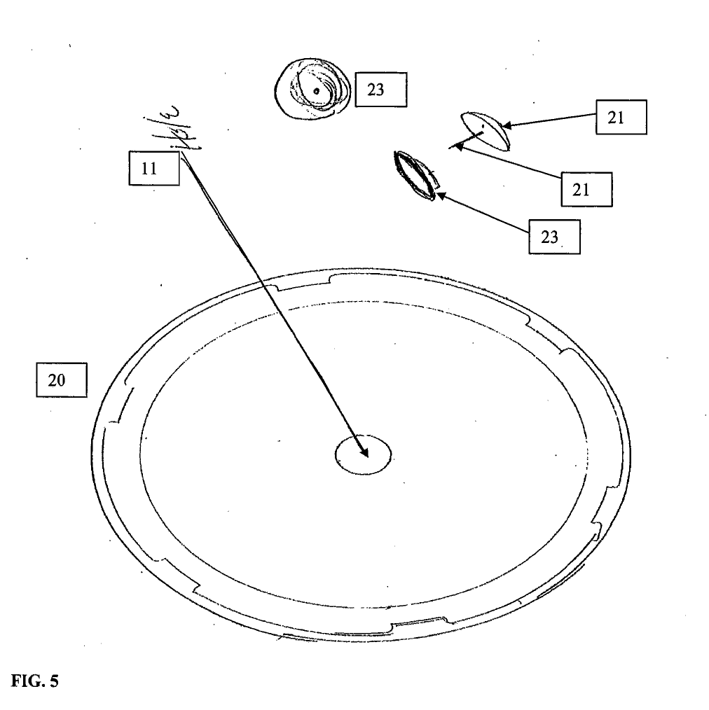

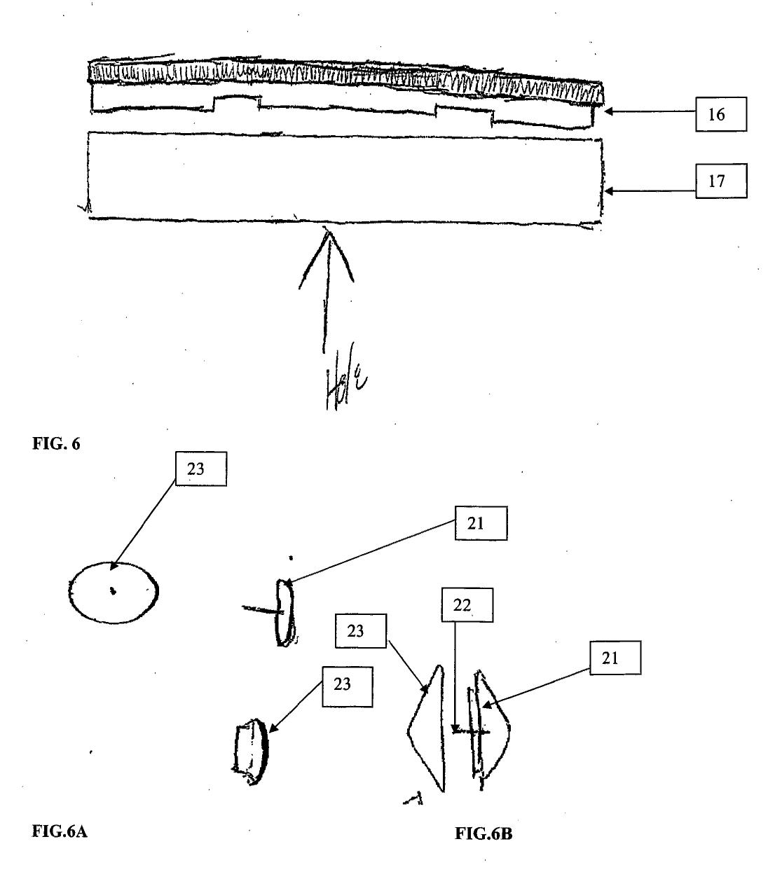

FIG. 1 illustrates an embodiment of a prior art disk securement device as found in the prior art, which is FIG. 5 in U.S. Pat. No. 7,602,300. FIG. 2 illustrates another embodiment of a prior art disk securement device as found in the prior art, which is FIG. 6 in U.S. Pat. No. 7,602,300. Although not explicitly shown herein, one of ordinary skill in the art will appreciate that the disc media package of FIGS. 1 and 2 could be modified as taught by the present art to implement the novel concepts of the present inventor. By the way of illustration and without limitation, a first way to implement the present art would be to modify the prior art illustrated in FIGS. 1 and 2 as follows:
1. Place apertures 11 in the top portion 16 and bottom portion 17 of the case 20 which are substantially aligned when the case 20 is closed as illustrated in FIGS. 3-4 and described as the disk apertures 11. One of ordinary skill in the art will appreciate that this is typically the center of the disk 15 and the aperture 11 may be placed through the disk pedestal 14 which serves as an inner hub to center and support the disk in the case. (Disk in case not shown) The aperture 11 may be placed in the center of the disk pedestal 14 without interfering with the operation or function of the disk pedestal, which is typically also placed at the center of the case 20. See also the prior art case 10 shown in FIGS. 1-2. It should be noted that the present art may also work in a case 10 not having a disk pedestal 14 located at the center of the disk 15. It should also be noted that although it is desirable to place the aperture 11 at the center of the generally square or rectangular case 20, it is not necessary nor is the present concept limited to a case having any particular shape. (See applicant's 2^{nd} embodiment, discussed herein.)
2. Insert a CD-rom or DVD disc (not shown) into the case 20 and rest on one side against one of the disk pedestals 13.
3. Close the case 20 so the top portion and bottom portion (16, 17) are adjacent and the disk is positioned interiorly therein. (not shown) The other side of the CD-rom or DVD may rest against the other opposing disk pedestal 14. (not shown) As will be apparent, the top and bottom portion (16, 17) are typically connected via a hinged portion 27.
4. Place the bottom or first portion of an EAS device 21 having a rod or pin portion 22 through the aperture 11 created in the bottom portion 17 of the case. The bottom or first portion of the EAS 21 will be generally positioned exterior of the CD or DVD with the wall 12 of the case positioned between the bottom or first portion of the EAS 21 and CD or DVD disk and the opposite end of the EAS pin 22 jutting through the CD or DVD disc center and the wall of the top portion 16 of the case 20. (DVD not shown)
5. Secure the disc within the case 20 by locking or engaging the top or second portion of the EAS device 23 with the EAS pin 22 jutting out from through the CD-rom or DVD disc center with the top or second portion of the EAS device 23. The top or second portion of the EAS device 23 will generally be exterior of the exterior of the CD or DVD with a wall 12 of the case positioned between the top or second first portion of the EAS 23 and the CD or DVD disk. This embodiment of the present art is illustrated in FIGS. 3-4.

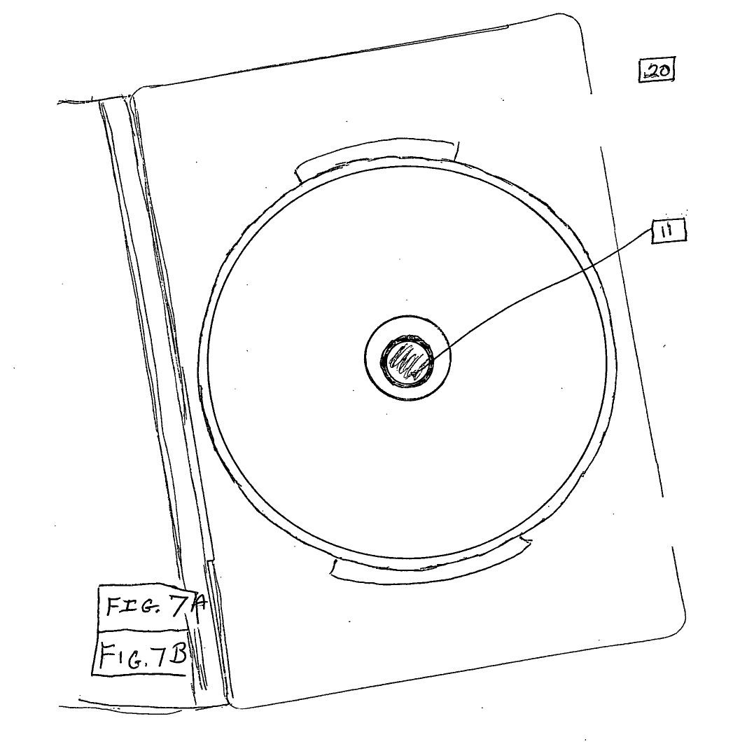

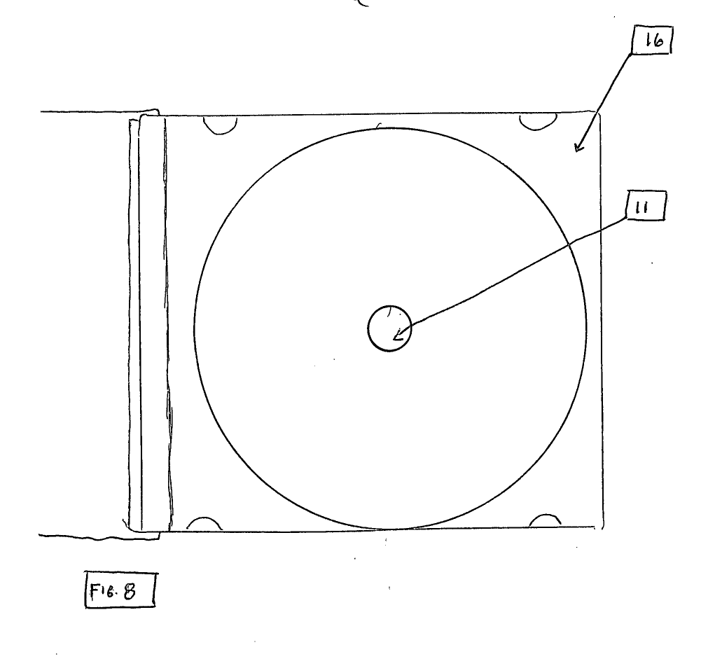

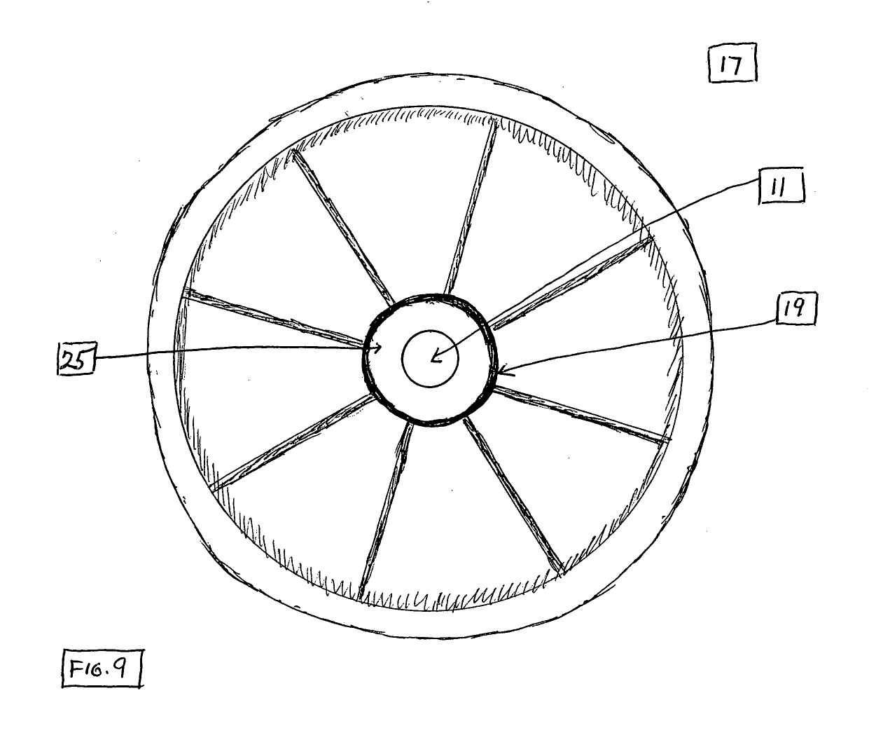

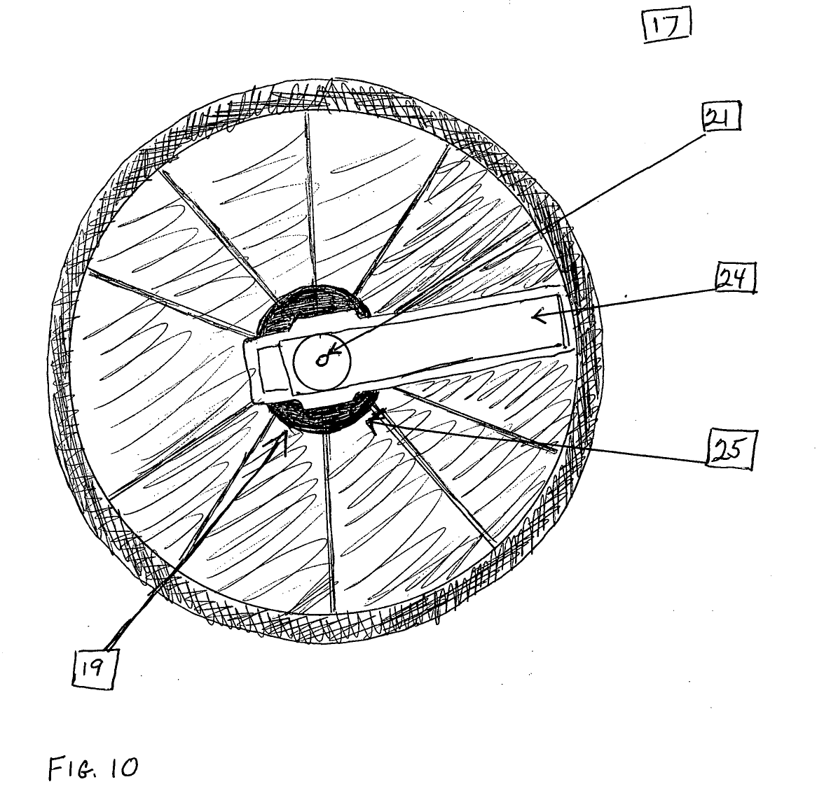

FIGS. 5-10 illustrate another embodiment of the present art optical media container and an EAS device configured to work with the optical media container. In this embodiment, the case 20 has a circular shape and does not have a hinged portion connecting the top and bottom portions of the case. By way of illustration and without limitation, this second embodiment of the present art case 20 may be implemented as follows:
A. Apertures 11 are placed in the top portion 16 and bottom portion 17 of a case 20 which are substantially aligned when the case 20 is closed as illustrated in FIGS. 7-10. One of ordinary skill in the art will appreciate that this is typically the center of the disk 15. Although not shown in FIGS. 5-10, the aperture 11 may be placed through the interior of the disk pedestal 14 which serves as an inner hub to center and support the disk in the case. The embodiment shown at FIGS. 5-10 is without an interiorly positioned disk pedestal. (Disk in case shown at FIG. 7B only) The aperture 11 may be placed in the center of the disk pedestal 14 without interfering with the operation or function of the disk pedestal, which is typically also placed at the center of the case 20. See also the prior art case 10 shown in FIGS. 1-2. It should be noted that the present art may also work in a case 10 not having a disk pedestal 14 located at the center of the disk 15.
B. Insert a CD-rom or DVD disc (shown at FIG. 7B) into the case 20 and rest on one side against the interior of either the top or bottom portion (16, 17) of the case 20.
C. Close the case 20 so the top portion and bottom portion (16, 17) are adjacent and the disk is positioned interiorly therein as illustrated in FIG. 7B. The other side of the CD-rom or DVD may rest against the interior of the case 58. As will be apparent to one of ordinary skill in the art, the top and bottom portion (16, 17) in this particular embodiment are not connected via a hinged portion but could be without departing from the intent of this disclosure.
D. Place the bottom or first portion of an EAS device 21 having a rod or pin portion 22 through the aperture 11 created in the bottom portion 17 of the case. The bottom or first portion of the EAS 21 will be generally positioned exterior of the CD or DVD with the wall 12 of the case positioned between the bottom or first portion of the EAS 21 and CD or DVD disk and the opposite end of the EAS pin 22 jutting through the CD or DVD disc center and the wall of the top portion 16 of the case 20. (Not shown)
E. Secure the disc within the case 20 by locking or engaging the top or second portion of the EAS device 23 with the EAS pin 22 jutting out from through the CD-rom or DVD disc center with the top or second portion of the EAS device 23. The top or second portion of the EAS device 23 will generally be exterior of the exterior of the CD or DVD with a wall 12 of the case positioned between the top or second first portion of the EAS 23 and the CD or DVD disk. This embodiment of the present art is illustrated in FIG. 10. As shown in FIG. 10, the EAS 24 is positioned exterior of the bottom of the case 17. The EAS device as shown has not been modified. It should be understood that the shape of the EAS device of the present art may also be modified to fit into the recess 25 of the case 20 shown in FIG. 10. In this way, the recess 25 of the bottom portion 17 of case 20 acts as a receptacle or receiver for the EAS device 23 within aperture wall 19 which may surround all or a portion of the of said EAS device 24. One advantage of an embodiment having a receptacle for insertion of the EAS device 23 is that the thickness of the case may be reduced and the external features of the case may be uniform, consistent and relatively flat allowing the cases 20 to be stacked together to decrease space necessary to store or display the cases 20.

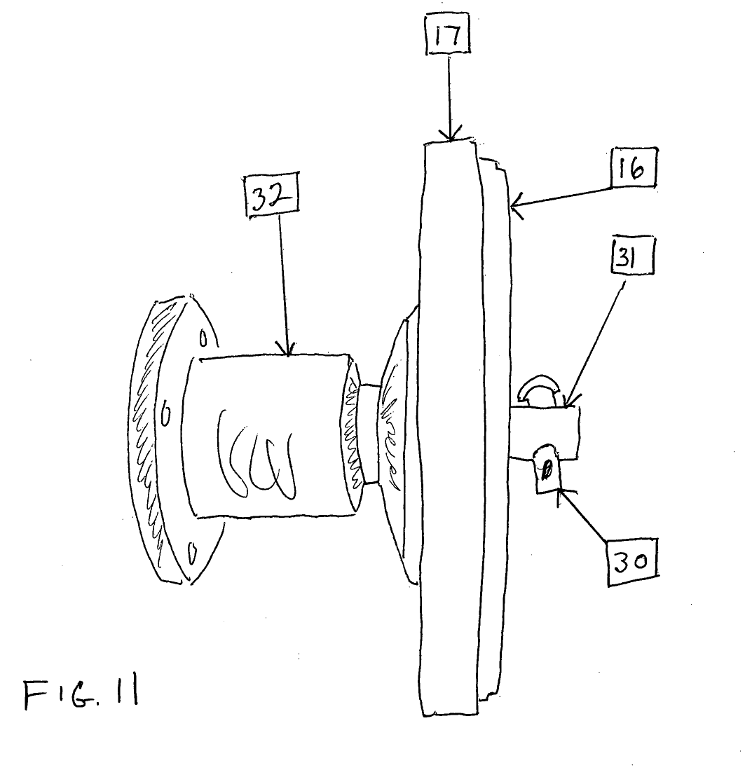

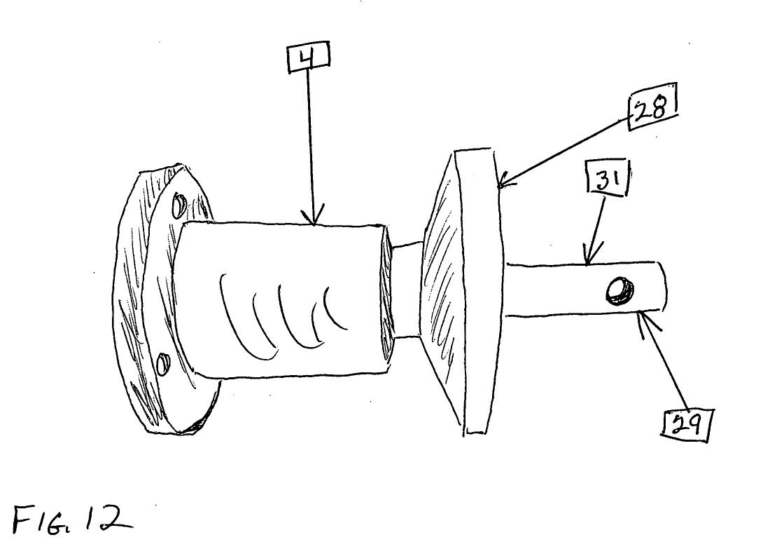

FIG. 11 illustrates another embodiment of the present art disc securement method disclosed herein is mounted upon a base portion 32. FIG. 12 illustrates the top view of FIG. 11. In this embodiment the case 20 may be fitted to a base portion 32 having an enlarged portion 33 which may not be slid through the apertures 11. The enlarged portion 33 may be employed with or without shield 28, which provides additional security and reduces the likelihood of removal of the base portion 32 from the case 20 to allow removal of the disk within. Additionally, although not shown, the base portion 32 may be modified to work with an EAS device 24. Although not shown, it will be obvious to one of ordinary skill based on this disclosure that the base portion 32 may be configured to serve as the bottom portion of the EAS device 21 to work with the case 20, EAS pin 22 and EAS top portion 23.

As shown in FIGS. 11 and 12, to further enhancement the physical structure of the securement device, the base portion may be modified to include a centering cylinder 31 having a pin hole placed therein to allow insertion of a locking pin 30, after insertion of the disk 26 into the case 20 on the side opposite the enlarged portion 33. Additionally, this embodiment may be employed with or without shield 28, which provides additional security and reduces the likelihood of removal of the base portion 32 from the case 20 to allow removal of the disk within. This embodiment may also be modified to work with an EAS device 24.

Having described the preferred embodiment, other features of the disk media securement device and methods will undoubtedly occur to those versed in the art, as will numerous modifications and alterations in the embodiments as illustrated herein, all of which may be achieved without departing from the spirit and scope of the present disclosure. It should be noted that the disk media securement device or case 20 are not limited to the specific embodiments pictured and described herein, but are intended to apply to all similar apparatuses and methods for securing disc media. Modifications and alterations from the described embodiments will occur to those skilled in the art without departure from the spirit and scope of the case 20 or mounting base 32.

1. An optical media case comprising:
a. A top portion having a first aperture;
b. A bottom portion having a second aperture;
c. A hinged portion, said hinged portion connected between said top portion and said bottom portion to form an enclosure;
d. An EAS device, said EAS device comprising:
i. A first portion;
ii. A second portion; and,
iii. A connector, said first portion and said second portion attached to each other via said connector;
e. An optical media having a central opening, wherein said optical media may be placed between said first portion and said second portion to fully enclose said optical media and so that said first aperture, said second aperture and said central opening are aligned and wherein said EAS device first portion is located external and adjacent said top portion, said EAS device second portion is located external and adjacent said bottom portion and said connector is positioned within said central opening of said optical media.

2. The optical media case according to claim 1 wherein said EAS device is activated upon attachment and enclosure of said optical media and after activation, separation of said first portion from said second portion of said EAS device triggers an alarm indicating tampering with the optical media packaging to deter theft.

3. The optical media container according to claim 1 wherein the container is generally round in shape.

4. The optical media container according to claim 1, 2 or 3 wherein said EAS device has a generally round shape.

5. The optical media case according to claim 1, 2, 3, or 4 wherein said EAS device is sized to fit within the opening of the optical media.

6. The optical media case according to claim 1, 2, 3, 4, or 5 wherein at least one recessed portion is proximate an aperture and is sized to allowed insertion of at least one portion of an EAS device.

7. The optical media case according to claim 1, 2, 3, 4, 5 or 6 wherein said recessed portion is formed by at least one wall which is proximate an aperture and is sized to allow insertion of a portion of an EAS device.

8. The optical media case according to claim 1, 2, 3, 4, 5, 6, or 7 further comprising a mounting base configured for attachment to said optical media case.

9. The optical media case according to claim 1, 2, 3, 4, 5, 6, 7 or 8 wherein said mounting base is configured with an axial opening distally positioned to accept a locking pin after engagement with said optical media.

10. A retail security system according to claim 1, 2, 3, 4, 5, 6, 7, 8 or 9 wherein said EAS device is activated upon attachment and enclosure of said optical media and after activation, separation of said first portion from said second portion of said EAS device triggers an alarm indicating tampering with the optical media packaging to deter theft.

11. A dvd package comprising a box having four sides to enclose a dvd, said box having a pair of internally positioned opposing nubs to engage with the opening in said dvd and to fix the position of the dvd within said box, said nubs having an opening in communication with the exterior of the package.

12. The dvd package according to claim 8 having a dvd enclosed within an EAS triggering device positioned at the exterior of the package and within the nubs to secure the package to the dvd.

13. A retail security system according to claim 7 or 8 wherein said EAS device is activated upon attachment and enclosure of said DVD and after activation, opening of said dvd package to remove said dvd from said dvd package triggers an alarm.

14. A method of security comprising any new inventive step, act, combination of steps, and/or acts or sub-combination of steps and/or acts described herein related to optical media packaging.

15. An apparatus comprising any new inventive step, act, combination of steps, and/or acts or sub-combination of steps and/or acts described herein related to optical media security.
